(19) United States
(12) Patent Application Publication
(10) Pub. No.: US 2004/0128494 A1
(43) Pub. Date: Jul. 1, 2004

(54) Method and apparatus for deploying managed code in a pre-boot environment

(76) Inventors: Vincent J. Zimmer, Federal Way, WA (US); Michael A. Rothman, Gig Harbor, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/330,596

(22) Filed: Dec. 27, 2002

(51) Int. Cl. G06F 9/445

(52) U.S. Cl. 713/2

(57) ABSTRACT

A method and apparatus for deploying managed code in a pre-boot environment is presented. In this regard, a managed BIOS is introduced to be executed in response to receipt of an indication associated with an initialization event, to establish a memory mapping, and to establish one or more containers within mapped memory within which one or more option ROM's (Read Only Memory) are executed, wherein option ROM operation is monitored to ensure the option ROM does not access a memory location not assigned to the option ROM by the managed BIOS.

### TECHNICAL FIELD

Embodiments of the present invention generally relate to the field of software and, more particularly, to a method and apparatus for deploying managed code in a pre-boot environment.

### BACKGROUND

An electronic appliance, an example of which is a computing device, may have multiple software programs that are executed in order to power-on (colloquially referred to as boot) the electronic appliance. One example of such a software program is the basic input/output system software (BIOS). In addition, some electronic appliances contain peripherals that include a type of BIOS known as an option read only memory (option ROM), which is sometimes also referred to as a device driver, which allows the peripheral to interact properly with the main BIOS of the electronic appliance. Firmware is a term used to describe software, including BIOS, option ROM's, and device drivers, that interact directly with the hardware (components) of an electronic appliance.

The BIOS and option ROM's of an electronic appliance typically initialize the hardware devices within the electronic appliance during a power-on self test (POST) after a power-on event, for example the pressing of the power button. The BIOS then typically hands over control of the electronic appliance to an operating system, for example an operating system from Microsoft Corporation, which allows a user to interact with the electronic appliance.

Problems may occur in booting the electronic appliance with an option ROM that is defectively or maliciously programmed so as to interfere with the functionality of the main BIOS or other option ROM's. These problems can be caused by the fact that BIOS and option ROM's share use of the same memory devices. If an option ROM tries to use certain memory that is already used by another software program, for example by BIOS or another option ROM, it could result in a failure to boot.

### BRIEF DESCRIPTION OF THE DRAWINGS

Embodiments of the present invention is illustrated by way of example, and not by way of limitation, in the figures of the accompanying drawings in which like reference numerals refer to similar elements and in which:

FIG. 1 is a block diagram of an example electronic appliance suitable for implementing the managed BIOS, in accordance with one example embodiment of the invention;

FIG. 2 is a block diagram of an example managed BIOS, in accordance with one example embodiment of the invention;

FIG. 3 is a graphical illustration of an example data structure suitable for use in accordance with the managed BIOS, in accordance with one example embodiment of the invention;

FIG. 4 is a flow chart of an example method for booting an electronic appliance, in accordance with one example embodiment of the invention; and

FIG. 5 is a flow chart of an example method for implementing a managed BIOS, in accordance with one example embodiment of the invention.

### DETAILED DESCRIPTION

Embodiments of the present invention are generally directed to a method and related apparatus for deploying managed code in a pre-boot environment. In this regard, a managed basic input/output system (managed BIOS) is presented which employs an innovative method to protect memory in the pre-boot (prior to loading of an operating system) environment. Those skilled in the art will appreciate, from the description to follow, that the method enabled by the managed BIOS facilitates detection of and response to an unauthorized memory access. Thus, the managed BIOS may reliably boot an electronic appliance.

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

FIG. 1 is a block diagram of an example electronic appliance suitable for implementing the managed BIOS, in accordance with one example embodiment of the invention. Electronic appliance 100 is intended to represent any of a number of devices including, but not limited to: a computer, a communication appliance, a network device, a multimedia device, a household appliance, etc. Electronic appliance 100 includes controller(s) 102, bus 104, system memory 106, display interface 108, video display interface 110, input/output interface(s) 112, keyboard/pointing device(s) 114, network interface 116, fixed storage device(s) 118, removable storage device(s) 120, RAM 122, application(s) 124, data 126, ROM 128, and managed BIOS 130 coupled as shown in FIG. 1. Managed BIOS 130, as described more fully hereinafter, may well be used in electronic appliances of greater or lesser complexity than that depicted in FIG. 1. Also, the innovative memory management attributes of managed BIOS 130, as described more fully hereinafter, may well be embodied in a combination of hardware and software.

Electronic appliance 100 includes controller(s) 102 for processing information. An example of a controller 102 is a 32-bit Intel® Architecture (IA-32) microprocessor. As used herein, controller(s) 102 control the overall operation of electronic appliance 100. Electronic appliance 100 further includes bus 104, which is coupled with controller 102, to facilitate the transfer of data within electronic appliance 100.

System memory 106 comprises random access memory (RAM) 122 that is coupled with bus 104 for storing information and instructions to be executed by controller 102. System memory 106 also can be used for storing temporary variables or other intermediate information during execution of instructions by controller 102. Typically, applications 124 and data 126 are stored in RAM 122 when they have been or will soon be used by controller 102, because of the quick access capabilities of RAM 122. RAM 122 may comprise any of a number of dynamic random access memory (DRAM) technologies available. In one embodiment, RAM 122 comprises Direct Rambus DRAM (RDRAM). In an alternate embodiment, RAM 122 comprises double data rate synchronous DRAM (DDR SDRAM). System memory 106 typically has to be initialized on every boot, because it is possible for a user to add memory modules to and/or remove memory modules from system memory 106 prior to powering on electronic appliance 100.

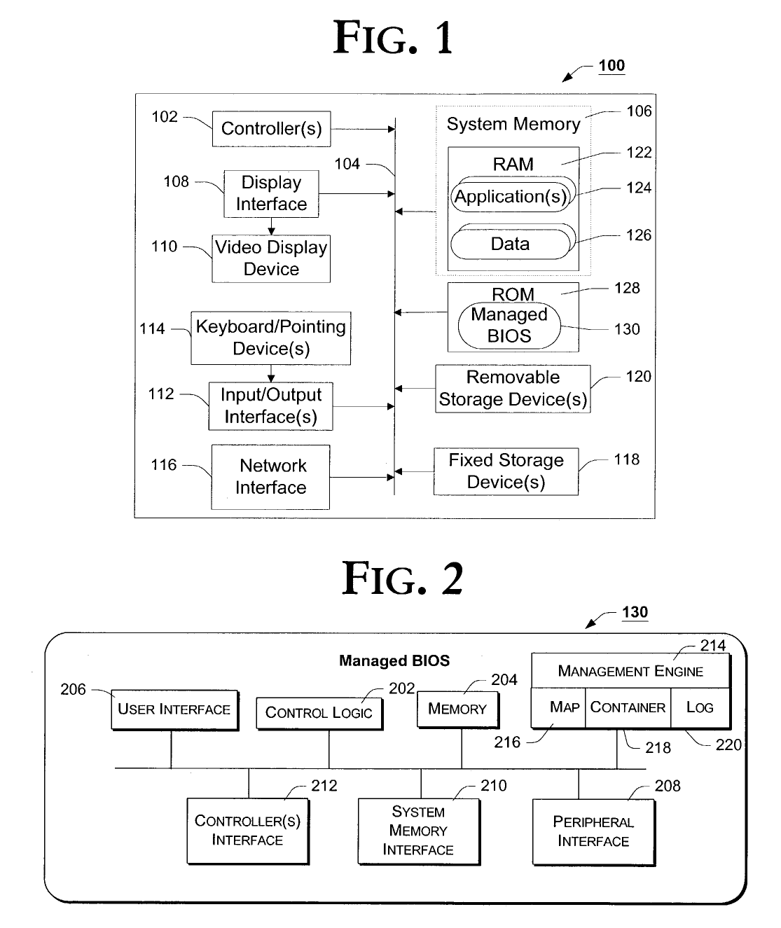

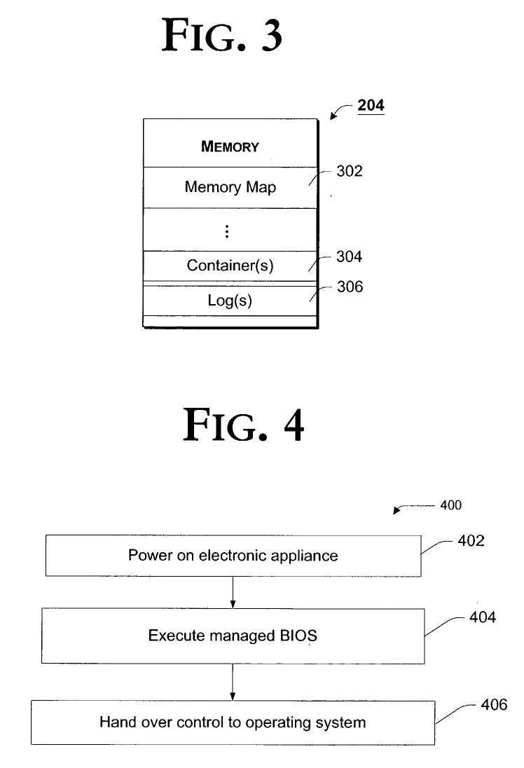

ROM 128 is typically non-volatile and has the ability to retain its contents while using little or no power. In one embodiment, ROM 128 is a plurality of complimentary metal-oxide silicon (CMOS) memories. In an alternate embodiment, ROM 128 is a flash memory. In yet another embodiment, ROM 128 is a combination of CMOS and flash memories. ROM 128 is used to store managed BIOS 130, which is a software program that enables electronic appliance 100 to function by initializing components and/or managing system memory 106 while option ROM's initialize components when electronic appliance 100 is powered on, as presented in greater detail with reference to FIG. 2. In one embodiment, managed BIOS 130 is copied to RAM 122 when electronic appliance 100 is first powered on for quick access at any time.

Electronic appliance 100 includes display interface 108, which in turn is coupled with video display device 110, such as a cathode ray tube (CRT) or liquid crystal display (LCD), for displaying information to a computing device user. Keyboard/pointing device(s) 114, including alphanumeric and other keys and a mouse, a trackball, or cursor direction keys, are typically coupled with bus 104 via an input/output interface 112 for communicating information, command selections, and cursor movement to controller 102.

Electronic appliance 100 further includes network interface 116 that provides access to a network (not shown in FIG. 1). In one embodiment, network interface 116 is a network interface card (NIC); however, other network interfaces can also be used.

Bus 104 can be a single bus or a plurality of busses that provide interconnection to the components of electronic appliance 100. In one embodiment bus 104 includes separate busses exclusively for memory access and display access.

Fixed storage device(s) 118, which typically are magnetic media drives, provide relatively large amounts of storage for applications and data. In one embodiment, fixed storage device(s) 118 comprises a hard drive with an operating stored thereon.

Removable storage device(s) 120, such as a floppy disk drive (a magnetic media drive) or CD-ROM drive (an optical media drive), provide high capacity storage of applications and data that may be needed by controller 102. The media used for storage can be easily removed and replaced from the drive by the user.

FIG. 2 is a block diagram of an example managed BIOS architecture, in accordance with one example embodiment of the invention. As shown, managed BIOS 130 includes one or more of control logic 202, memory 204, user interface 206, peripheral interface 208, system memory interface 210, controller(s) interface 212, and management engine 214 coupled as shown in FIG. 2. In accordance with one aspect of the present invention, to be developed more fully below, managed BIOS 130 includes a management engine 214 comprising one or more of mapping services 216, container services 218, and/or logging services 220. It is to be appreciated that, although depicted as a number of disparate functional blocks, one or more of elements 202-220 may well be combined into one or more multi-functional blocks. Similarly, management engine 214 may well be practiced with fewer functional blocks, i.e., with only logging services 220, without deviating from the spirit and scope of the present invention. In this regard, managed BIOS 130 in general, and management engine 214 in particular, are merely illustrative of one example implementation of one aspect of the present invention.

As introduced above, managed BIOS 130 initializes components and/or manages system memory 106 while option ROM's initialize components when electronic appliance 100 is powered on. In one embodiment, managed BIOS 130 performs most of the functions of a conventional BIOS, such as initializing system memory 106, and then manages system memory 106 during the loading of option ROM's, before finally initiating the loading of an operating system.

As used herein control logic 202 provides the logical interface between managed BIOS 130 and electronic appliance 100. In this regard, control logic 202 manages one or more aspects of managed BIOS 130 to provide a communication interface from electronic appliance 100 to extended BIOS elements resident thereon. According to one aspect of the present invention, control logic 202 receives initialization event indications such as, e.g., an interrupt, from bus 104 indicating a power-on event. Upon receiving such an indication, control logic 202 selectively invokes the resource(s) of management engine 214. As part of an example boot method, as explained in greater detail with reference to FIG. 5, control logic 202 selectively invokes mapping services 216 and container services 218 that establish a memory map for system memory 106 and establish containers of memory within which option ROM's may operate, respectively. Control logic 202 also selectively invokes logging services 220, as explained in greater detail with reference to FIG. 5, to retain information about any option ROM that performs an unauthorized memory access, in other words, any option ROM that attempts to operate on memory outside a given container. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. Control logic 202 may also be implemented as controller(s) 102. In alternate implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, memory 204 may well include volatile and non-volatile memory elements, possibly RAM 122 and/or ROM 128. In accordance with one aspect of the present invention, memory 204 includes non-volatile memory element(s) used to maintain memory management information. According to one example implementation, the non-volatile memory elements are comprised of electronically erasable programmable read-only memory (EEPROM) element(s) (not specifically denoted). A graphical illustration of an example memory 204 is presented with reference to FIG. 3.

User interface 206 allows control logic 202 to gain access to video display device 110, in one embodiment, as part of logging services 220 to convey a message notifying a user of an option ROM that performed an unauthorized memory access.

Peripheral interface 208 provides a path through which control logic 202 can identify option ROM's that are associated with peripherals within electronic appliance 100, as part of container services 218.

System memory interface 210 and controller(s) interface 212 provide a conduit for control logic 202 to access and communicate with system memory 106 and controller(s) 102, respectively, as part of mapping services 216 and container services 218.

Management engine 214, as introduced above, is selectively invoked by control logic 202 to manage system memory 106. In accordance with the illustrated example implementation of FIG. 2, management engine 214 is depicted comprising one or more of mapping services 216, container services 218 and logging services 220. Although depicted as a number of disparate elements, those skilled in the art will appreciate that one or more elements 216-220 of management engine 214 may well be combined without deviating from the scope and spirit of the present invention.

As introduced above, mapping services 216 provide managed BIOS 130 with the ability to establish a memory map. In one example embodiment, mapping services 216 is compliant with the POST (Power On Self Test) Memory Manager (PMM) Specification, version 1.01, published Nov. 21, 1997, by Phoenix Technologies Ltd., and Intel Corporation, to assign memory usage below the first 1 Mega-Byte (MB) of system memory 106. In an alternate embodiment, mapping services 216 is compliant with the Extensible Firmware Interface (EFI) Specification, version 1.10, review draft version 0.95, published Apr. 15, 2002, by Intel Corporation, to assign EFI memory map space.

Container services 218, as introduced above, provide managed BIOS 130 with the ability to detect and respond to unauthorized memory accesses. In one example embodiment, container services 218 utilize the task state segment (TSS), described in the IA-32 Intel® Architecture Software Developer's Manual, volume 3, published by Intel Corporation, to create a virtual 8086 (V86) container, which turns on paging with unallocated memory being marked as unavailable. In this way, a page-fault (interrupt) occurs if accessing memory outside of a container. In an alternate embodiment, container services 218 utilize a firmware EFI Byte Code (EBC) interpreter to validate memory requests against an EFI memory map. In another embodiment, container services utilize a IEEE1275 OpenFirmware/OpenBoot interpreted FCODE ROM interpreter to validate memory requests against the OpenFirmware memory map. In another embodiment, native EFI binaries, that run in either flat, protected mode on IA32 or virtual mode on Itanium, shall use paging mechanism of the associated processor in order to map the address space in a 1:1 fashion between virtual and physical, with memory that has not been allocated to drivers marked as not-present; this will engender a page fault into the controlling firmware core whenever an errant memory access occurs in a managed piece of code. In some embodiments, container services 218 locates an option ROM and loads it into a container unique to that option ROM. In other embodiments, multiple option ROM's may be loaded into the same container.

As introduced above, logging services 220 provide managed BIOS 130 with the ability to store information about an option ROM that performed an unauthorized memory access, as identified by container services 218. In one embodiment, logging services 220 is implemented as a page-fault handler routine, in response to a page-fault, that identifies and records the identity of an option ROM that performed an unauthorized memory access. One skilled in the art would appreciate that logging services 220 is but one example of an action that may be taken in response to an unauthorized memory access, and the present invention is not limited to this particular example action. In an alternate embodiment, logging services 220 also displays a notification to video display device 110.

FIG. 3 is a graphical illustration of an example data structure suitable for use in accordance with managed BIOS 130, in accordance with one example embodiment of the invention. Memory 204 stores memory map 302, container(s) 304, and log(s) 306.

As used herein, memory map 302 may include information regarding a current memory map that has been established by mapping services 218.

Container(s) 304, as used herein, may include information regarding current container(s) that have been established by container services 220.

Accesses to memory outside of container(s) 304 are logged by logging services 220 in log(s) 306. In one embodiment, log(s) 306 contains the addresses of option ROM's that have performed an unauthorized memory access. Log(s) 306 may be retained and utilized by managed BIOS 130 on a subsequent boot to prevent the offending option ROM's from loading.

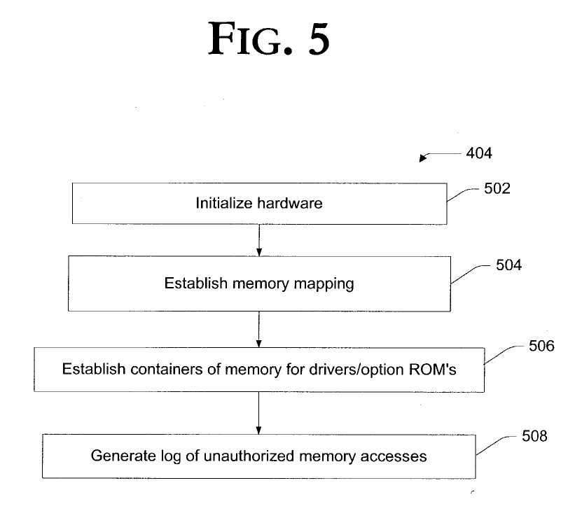

FIG. 4 is a flow chart of an example method for booting an electronic appliance, in accordance with one example embodiment of the invention. The method begins with a power on (402) of the electronic appliance 100. In one embodiment, a user performs the power-on by pushing a power button on the electronic appliance 100. In an alternate embodiment, a device communicatively coupled with network interface 116 performs the power-on by sending a signal to electronic appliance 100.

Next, managed BIOS 130 is executed (404) as presented in greater detail with reference to FIG. 5. Finally, control of electronic appliance 100 is handed over (406) to an operating system, which may load from fixed storage device(s) 118, removable storage device(s) 120, or a storage device communicatively coupled with network interface 116, and which provides the user with an interface to interact with electronic appliance 100.

FIG. 5 is flow chart of an example method for implementing managed BIOS 130 (404), in accordance with one example embodiment of the invention. The method begins with initializing (502) of hardware. In one embodiment, system memory 106 is initialized by managed BIOS 130 in a manner commonly utilized by a conventional BIOS.

Next, mapping services 216 establishes (504) a memory map 302 for system memory 106. In one embodiment, the contents of mapping services 216 cause controller(s) 102 to manage system memory 106.

Container services 218 then establishes (506) container(s) 304, which serve as virtual boundaries within system memory 106. In one embodiment, the contents of container services 218 cause controller(s) 102 to assert an interrupt when an area of system memory 106 outside of a boundary of container(s) 304 is accessed.

Lastly, logging services 220 generates (508) log(s) 306 for substantially all access to memory outside of the container into which memory was allocated. In one embodiment, electronic appliance 100 is also rebooted, with log(s) 306 used to prevent offending option ROM's from being loaded.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method of booting an electronic appliance, the method comprising:
executing a BIOS (Basic Input/Output System) in response to receipt of an indication associated with an initialization event;
establishing a memory mapping; and
establishing one or more containers within mapped memory by the BIOS within which one or more option ROM's (Read Only Memory) are executed, wherein option ROM operation is monitored to ensure the option ROM does not access a memory location not assigned to the option ROM by the BIOS.

2. The method of claim 1, further comprising logging unauthorized memory accesses for use in a subsequent boot.

3. The method of claim 2, further comprising disabling, during the subsequent boot, the option ROM that performed the unauthorized memory access.

4. The method of claim 2, further comprising terminating booting as a result of the unauthorized memory access.

5. The method of claim 2, further comprising handing control over to an operating system loader.

6. An electronic appliance, comprising:
a system memory to store one or more of a BIOS (Basic Input/Output System) and option ROM's (Read Only Memory); and
control logic, coupled with the system memory, to selectively execute the BIOS and option ROM's, the BIOS to map the system memory and establish one or more containers within which the option ROM's are executed.

7. The electronic appliance of claim 6, wherein the containers to monitor option ROM operation to detect an access to a memory location not assigned to the option ROM.

8. The electronic appliance of claim 7, wherein the BIOS to establish a log of the option ROM(s) that performed unauthorized access (es) of memory.

9. The electronic appliance of claim 8, wherein the BIOS to disable, on a subsequent boot, the logged option ROM(s).

10. The electronic appliance of claim 6, wherein the BIOS is compliant with the Extensible Firmware Interface (EFI) standard.

11. A storage medium comprising content which, when executed by an accessing machine, invokes an instance of management services in the accessing machine, the management services, independent of a functional operating system executing on the accessing machine, to establish a memory map of the accessing machine, to establish containers of memory within which content to boot the accessing machine is authorized to access, and to detect access to memory outside the container(s).

12. The storage medium of claim 11, further comprising content which, when executed by the accessing machine, causes the accessing machine to create a log of the content that performs accesses to memory outside the container(s).

13. The storage medium of claim 12, further comprising content which, when executed by the accessing machine, causes the accessing machine to disable the logged content.

14. The storage medium of claim 13, wherein the content is automatically accessed by the accessing machine after a power-on event.

15. The storage medium of claim 11, further comprising content which, when executed by the accessing machine, causes the accessing machine to load an operating system.
